(19) United States
(12) Patent Application Publication
(10) Pub. No.: US 2013/0298756 A1
(43) Pub. Date: Nov. 14, 2013

(54) VACUUM LOCK

(71) Applicant: Yuriy Zakuskin, Orekhov (UA)

(72) Inventor: Yuriy Zakuskin, Orekhov (UA)

(21) Appl. No.: 13/447,268

(22) Filed: May 12, 2012

(51) Int. Cl. F16K 24/04; F16K 31/60; F16K 31/02

(52) U.S. Cl. 91/459; 91/418; 91/468

(57) ABSTRACT

A vacuum lock having a main body portion, a cylinder and a piston is described. The cylinder is disposed within the main body portion and has an opening. The cylinder has one or more sealing rings disposed on an inside surface and an air vent opposite the opening. The vacuum lock can further include a piston adapted to fit in the cylinder and guides. The vacuum lock can also include a valve coupled to the air vent.

Embodiments relate generally to locks, and more particularly, to a vacuum lock.

A vacuum lock having a main body portion, a cylinder and a piston is described. The cylinder is disposed within the main body portion and has an opening. The cylinder has one or more sealing rings disposed on an inside surface and an air vent opposite the opening. The vacuum lock can further include a piston adapted to fit in the cylinder and guides. The vacuum lock can also include a valve coupled to the air vent.

### BRIEF DESCRIPTION OF THE DRAWINGS

FIG. 1 shows a diagram of an example vacuum lock in accordance with at least one embodiment.

FIG. 2 shows a diagram of an example vacuum lock for installing in a door in accordance with at least one embodiment.

### DETAILED DESCRIPTION

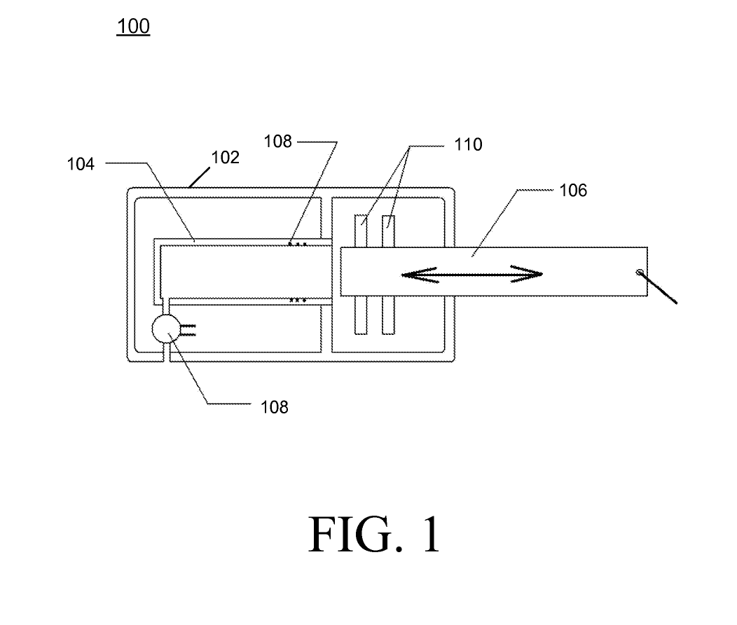

As shown in FIG. 1, a vacuum lock 100 includes a main body portion 102, a cylinder 104, a piston 106, sealing rings 108, guides 110 and a valve 112.

In operation, the valve 112 is opened (either electrically or manually) in order to release air from the cylinder 104 as the piston 106 is inserted. The piston 106 contacts the sealing rings 108. As the piston 106 slides against the sealing rings 108 air is forced from the cylinder 104 to the outside via the valve 112.

Once the piston 106 is fully inserted into the cylinder 104, the valve 112 can be closed. With the valve 112 closed, the piston 106 cannot be withdrawn from the cylinder due to vacuum pressure in the cylinder 104.

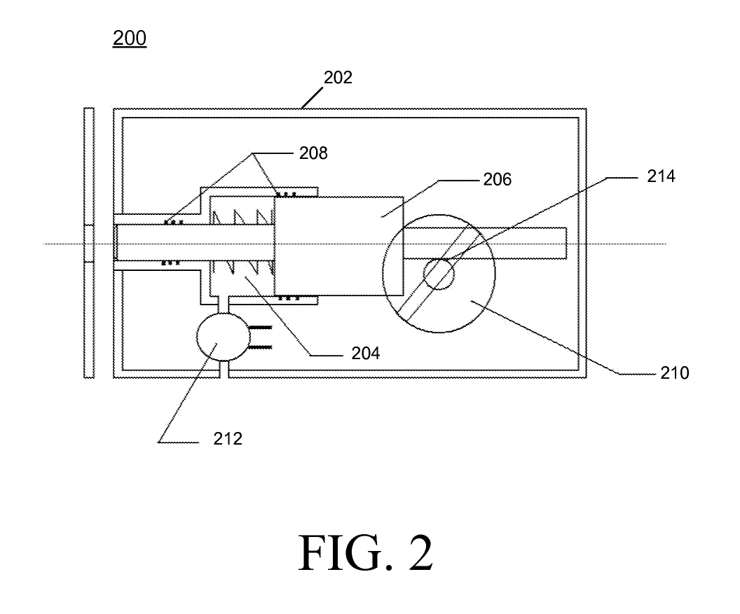

As shown in FIG. 2, a vacuum lock 200 includes a main body portion 202, a cylinder 204, a piston 206, two sets of sealing rings 208, a knob 210, a valve 212 and a gear drive 214.

In operation, the valve 212 is opened (either electrically or manually) in order to release air from the cylinder 204 as the piston 206 is inserted. The piston 206 contacts the sealing rings 208. As the piston 206 slides against the sealing rings 208 air is forced from the cylinder 104 to the outside via the valve 212. The cylinder 204 includes a first portion and a second portion. The first portion has a diameter larger than that of the second portion.

Once the piston 206 is fully inserted into the cylinder 204, the valve 212 can be closed. With the valve 212 closed, the piston 206 cannot be withdrawn from the cylinder 204 due to vacuum pressure. The valve 212 can be opened or closed and the piston 206 inserted or removed in response to rotation of the knob 210 (or rotation of a key lock, not shown).

It is, therefore, apparent that there is provided, in accordance with the various embodiments disclosed herein, vacuum locks.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A vacuum lock comprising:
a main body portion;
a cylinder disposed within the main body portion and having an opening, wherein the cylinder has one or more sealing rings disposed on an inside surface and an air vent opposite the opening;
a piston adapted to fit in the cylinder;
guides; and
a valve coupled to the air vent.

2. The vacuum lock of claim 1, wherein the valve is an electrically actuated valve.

3. The vacuum lock of claim 1, wherein the valve is a mechanically actuated valve.

4. The vacuum lock of claim 1, wherein the sealing rings are made of silicon.

5. The vacuum lock of claim 1, wherein the valve is a one way valve.

6. A vacuum lock comprising:
a main body portion;
a cylinder disposed within the main body portion and having an opening, a first portion and a second portion, wherein the cylinder has one or more sealing rings disposed on an inside surface of the first portion and an air vent disposed in the first portion;
a piston having a first piston portion and a second piston portion adapted to fit in the first cylinder portion and the second cylinder portion, respectively; and
a valve coupled to the air vent.

7. The vacuum lock of claim 6, wherein the valve is an electrically actuated valve.

8. The vacuum lock of claim 6, wherein the valve is a mechanically actuated valve.

9. The vacuum lock of claim 6, wherein the sealing rings are made of silicon.

10. The vacuum lock of claim 6, wherein the valve is a one way valve.

11. The vacuum lock of claim 6, further comprising a handle connected to a gear drive coupled to the piston.
